(19) United States
(12) Patent Application Publication
(10) Pub. No.: US 2024/0152130 A1
(43) Pub. Date: May 9, 2024

(54) APPARATUS FOR CONFIGURING EQUIPMENT BEHAVIOR CATALOG AND VIRTUAL PRODUCTION SYSTEM USING EQUIPMENT BEHAVIOR CATALOG

(71) Applicant: ELECTRONICS AND TELECOMMUNICATIONS RESEARCH INSTITUTE, Daejeon (KR)

(72) Inventors: Young Ae CHUN, Daejeon (KR); Ho Jin PARK, Daejeon (KR); Hark Jin LEE, Daejeon (KR); Ji Yeon SON, Daejeon (KR); Young Seog YOON, Daejeon (KR); Eun Seo LEE, Daejeon (KR); Seung Woog JUNG, Daejeon (KR)

(21) Appl. No.: 18/503,599

(22) Filed: Nov. 7, 2023

(30) Foreign Application Priority Data
Nov. 8, 2022 (KR) 10-2022-0148117
Jun. 19, 2023 (KR) 10-2023-0078501

(51) Int. Cl. G05B 19/418

(52) U.S. Cl. CPC G05B 19/41885; G05B 19/4188

(57) ABSTRACT

Disclosed are an apparatus for configuring an equipment behavior catalog (EBC) and a virtual production system using an EBC. The apparatus for configuring the EBC according to an aspect of the present invention includes an artificial intelligence model storage configured to store an artificial intelligence model, and an EBC storage configured to store an EBC including artificial intelligence model data for the artificial intelligence model stored in the artificial intelligence model storage.

### CROSS-REFERENCE TO RELATED APPLICATIONS

This application claims priority to and the benefit of Korean Patent Application Nos. 10-2022-0148117 and 10-2023-0078501, filed on Nov. 8, 2022 and Jun. 19, 2023, respectively, the disclosure of which is incorporated herein by reference in its entirety.

### BACKGROUND

### 1. Field of the Invention

The present invention relates to an apparatus for configuring an equipment behavior catalog and a virtual production system using an equipment behavior catalog.

### 2. Description of Related Art

Catalogs of equipment used in simulation of virtual production systems include only information about properties of the equipment, and thus there has been a limitation in accurately predicting the productivity and efficiency of smart virtual factories built with virtual production systems.

In order to overcome this limitation, the properties of the equipment as well as operation behavior of the equipment, such as operation conditions, state transitions, and operation results of the equipment, should be applied to simulation of the virtual production system, and thus an equipment behavior catalog (EBC), which includes the operation behavior of the equipment, is being standardized.

Further, in order to accurately predict the productivity and efficiency of smart virtual factories, a demand for integration of an artificial intelligence model and a simulation model has emerged.

The related art of the present invention is disclosed in Korean Laid-open Patent Publication No. 10-2018-0121346 (Nov. 7, 2018).

### SUMMARY OF THE INVENTION

The present invention is directed to providing a technique for optimizing an actual production system by linking a simulation model and an artificial intelligence model in order to accurately predict productivity and efficiency.

According to an aspect of the present invention, there is provided an apparatus for configuring an equipment behavior catalog (EBC), which includes an artificial intelligence model storage configured to store an artificial intelligence model, and an EBC storage configured to store an EBC including artificial intelligence model data for the artificial intelligence model stored in the artificial intelligence model storage.

The EBC may include at least one of properties of equipment, behavior of the equipment, and an external interaction with external equipment.

The properties of the equipment may include at least one of profile data, specification data, operation data, and data for the artificial intelligence model.

The artificial intelligence model data may include at least one of an artificial intelligence model identifier, an artificial intelligence model name, an input data set, output data, framework information, a framework help library, a model file, and a model source code.

The behavior of the equipment may include a state of the behavior, the state of the behavior may include at least one of a state identifier, a state name, an entry execution code, and an exit execution code of the behavior, and the entry execution code of the state of the behavior or the exit execution code of the state of the behavior may include the artificial intelligence model data.

The behavior of the equipment may further include a state transition of the behavior, the state transition of the behavior may include at least one of a state transition identifier, a state transition name, a state transition condition, a source state identifier, a destination state identifier, and a state transition execution code, and the state transition execution code may include the artificial intelligence model data.

The external interaction may include at least one of an external interaction identifier, an external interaction name, a source equipment identifier, a destination equipment identifier, a state identifier, a state entry execution code, a state exit execution code, a state transition identifier, a state transition condition, and a state transition execution code, and the state entry execution code, the state exit execution code, and the state transition execution code may include the artificial intelligence model data.

The artificial intelligence model may use a prediction function, input data of the prediction function may be data of the EBC, and output data of the prediction function may be static or dynamic values of one or more variables of a simulation model.

The EBC storage may be configured to store the artificial intelligence model.

In the EBC storage, data or a parameter of the EBC may be replaced with the artificial intelligence model, part or all of behavior of equipment may be replaced with the artificial intelligence model, or equipment serving as a component in complex equipment may be replaced with the artificial intelligence model.

According to another aspect of the present invention, there is provided a virtual production system using an EBC, which includes an apparatus for configuring an EBC configured to form and store artificial intelligence model data for an artificial intelligence model, and a simulation unit configured to perform simulation using the EBC to allow the artificial intelligence model to be embedded.

The apparatus for configuring the EBC may include an artificial intelligence model storage configured to store an artificial intelligence model, and an EBC storage configured to form and store an EBC including artificial intelligence model data for the artificial intelligence model stored in the artificial intelligence model storage.

The EBC may include at least one of properties of equipment, behavior of the equipment, and an external interaction with external equipment.

The properties of the equipment may include at least one of profile data, specification data, operation data, and data for the artificial intelligence model.

The artificial intelligence model data may include at least one of an artificial intelligence model identifier, an artificial intelligence model name, an input data set, output data, framework information, a framework help library, a model file, and a model source code.

The behavior of the equipment may include a state of the behavior, the state of the behavior may include at least one of a state identifier, a state name, an entry execution code, and an exit execution code of the behavior, and the entry execution code of the state of the behavior or the exit execution code of the state of the behavior may include the artificial intelligence model data.

The behavior of the equipment may further include a state transition of the behavior, the state transition of the behavior may include at least one of a state transition identifier, a state transition name, a state transition condition, a source state identifier, a destination state identifier, and a state transition execution code, and the state transition execution code may include the artificial intelligence model data.

The external interaction may include at least one of an external interaction identifier, an external interaction name, a source equipment identifier, a destination equipment identifier, a state identifier, a state entry execution code, a state exit execution code, a state transition identifier, a state transition condition, and a state transition execution code, and the state entry execution code, the state exit execution code, and the state transition execution code may include the artificial intelligence model data.

The artificial intelligence model may use a prediction function, input data of the prediction function may be data of the EBC, and output data of the prediction function may be static or dynamic values of one or more variables of a simulation model.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a block diagram of an apparatus for configuring an equipment behavior catalog and a virtual production system according to an embodiment of the present invention;

FIG. 2 illustrates a structure of an equipment behavior catalog according to an embodiment of the present invention;

FIG. 3 is a diagram illustrating components of a property set of the equipment behavior catalog of FIG. 2;

FIG. 4 is a diagram illustrating components of behavior of the equipment behavior catalog of FIG. 2;

FIG. 5 is a diagram illustrating components of an external interaction of the equipment behavior catalog of FIG. 2;

FIG. 6 is a diagram illustrating an example of an embedded artificial intelligence model according to an embodiment of the present invention; and

FIG. 7 is a data flow diagram of the case in which an equipment behavior catalog in which an artificial intelligence model according to an embodiment of the present invention is embedded is used.

### DETAILED DESCRIPTION OF EXEMPLARY EMBODIMENTS

Hereinafter, examples of an apparatus for configuring an equipment behavior catalog (EBC) and a virtual production system using an EBC according to embodiments of the present invention will be described. In this process, thicknesses of lines, sizes of components, and the like shown in the accompanying drawings may be exaggerated for clarity and convenience of description. Further, some terms which will be described below are defined in consideration of functions in the present invention and meanings may vary depending on, for example, a user or operator's intentions or customs. Therefore, the meanings of these terms should be interpreted based on the scope throughout this specification.

Hereinafter, embodiments that are easily performed by those skilled in the art will be described in detail with reference to the accompanying drawings. However, embodiments of the present invention may be implemented in several different forms, and are not limited to embodiments described herein. In addition, parts irrelevant to description are omitted in the drawings in order to clearly explain embodiments of the present invention. Similar parts are denoted by similar reference numerals throughout this specification.

Throughout this specification, when a certain part “includes” a certain component, it means that another component may be further included not excluding another component unless otherwise stated.

Implementations described herein may be implemented, for example, as a method, a process, a device, a software program, a data stream, or a signal. Although discussed only in the context of a single form of implementation (e.g., only as a method), implementations of the features discussed may also be implemented in other forms (e.g., devices or programs). The device may be implemented with appropriate hardware, software, firmware, etc. The method may be implemented in a device such as a processor, which is generally a processing device including a computer, microprocessor, integrated circuit, or programmable logic device.

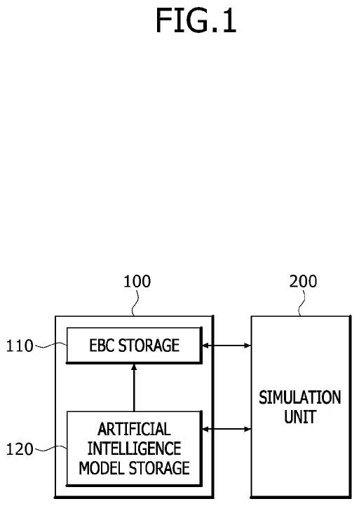

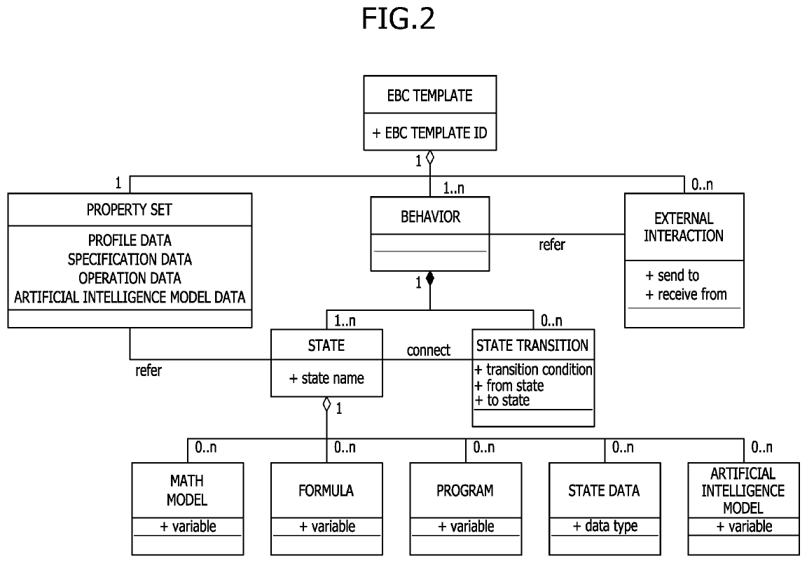

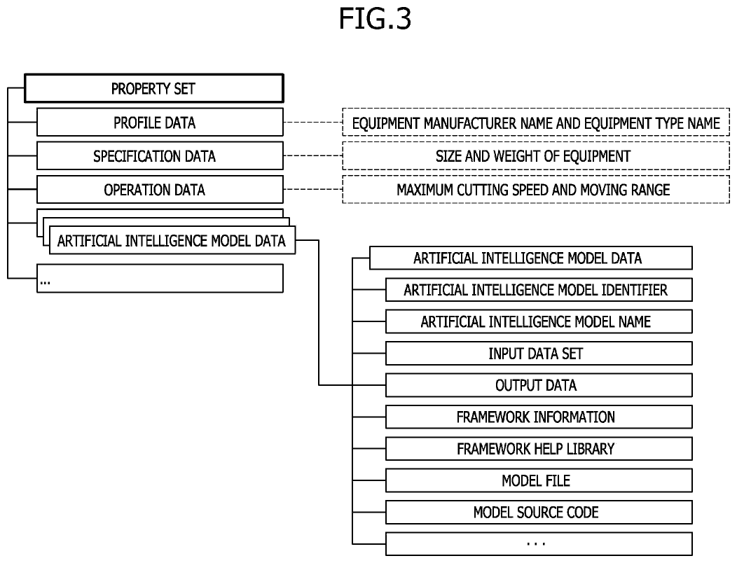

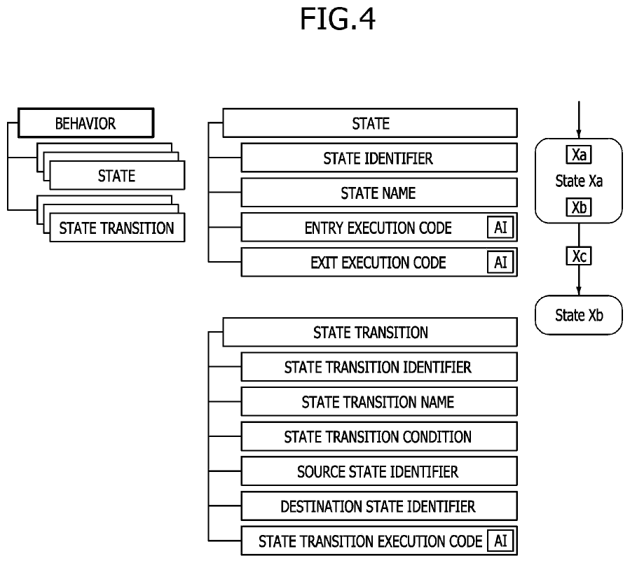

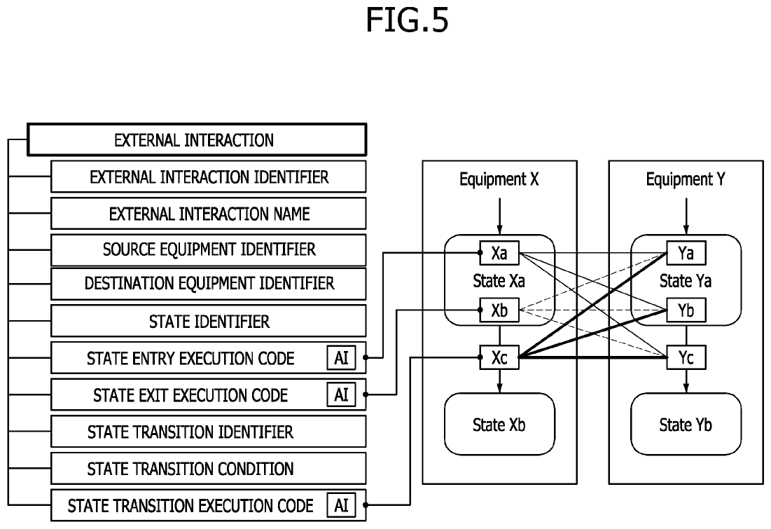

FIG. 1 is a block diagram of an apparatus for configuring an EBC and a virtual production system according to an embodiment of the present invention, FIG. 2 illustrates a structure of an EBC according to an embodiment of the present invention, FIG. 3 is a diagram illustrating components of a property set of the EBC of FIG. 2, FIG. 4 is a diagram illustrating components of behavior of the EBC of FIG. 2, and FIG. 5 is a diagram illustrating components of an external interaction of the EBC of FIG. 2.

Referring to FIG. 1, the virtual production system according to the embodiment of the present invention includes an apparatus 100 for configuring an EBC, and a simulation unit 200.

The apparatus 100 for configuring the EBC is configured to form and store an EBC including artificial intelligence (AI) model data for an AI model.

The apparatus 100 for configuring the EBC includes an EBC storage 110 and an AI model storage 120.

The AI model storage 120 is configured to store an AI model.

The AI model may be a pre-trained AI model.

AI model data for the AI model may be included in an EBC of the EBC storage 110.

The AI model data will be described with reference to FIGS. 2 to 7.

The AI model may replace data or a parameter of the EBC stored in the EBC storage 110, replace part or all of behavior of equipment, or replace equipment serving as a component in complex equipment.

Input data of the AI model may be data of the EBC.

The input data of the AI model may include at least one of data of equipment itself, product data, and operation data.

The input data of the AI model is not limited to data included in the EBC.

The input data of the AI model may be selected in various ways according to an embedded AI model.

Output data of the AI model may be static or dynamic values of one or more variables of a simulation model.

The AI model will be described below.

The EBC storage 110 is configured to form and store an EBC.

The EBC includes AI model data for an AI model.

When an AI model is stored in the AI model storage 120, the EBC storage 110 is configured to form and store an EBC including AI model data in conjunction with the AI model storage 120.

Further, in the EBC storage 110, data or a parameter of the EBC may be replaced with the AI model, part or all of behavior of equipment may be replaced with the AI model, or equipment serving as a component in complex equipment may be replaced with the AI model.

Further, in the EBC storage 110, an AI model may be newly added to the existing EBC.

Further, when the AI model is embedded in the EBC, the EBC in which the AI model is embedded may be used for simulation of the simulation unit 200.

The EBC may include information about mechanical characteristics of the corresponding equipment, a state of the equipment, and a hierarchical configuration of the equipment.

The state of the equipment may include information about operation of the equipment and energy consumed by the equipment, and the hierarchical configuration of the equipment may include information about a parent EBC and a child EBC.

Here, the information about the operation of the equipment may depend on a target product for which the corresponding equipment is used. The information about the energy consumed by the equipment may depend on settings of the equipment. Further, the settings of the equipment may include information about a driving device, dynamics, and power. The hierarchical configuration of the equipment may include information about the case in which one or more pieces of equipment are integrated to perform a specific function.

When the corresponding equipment corresponds to auxiliary equipment, the information about the parent EBC may include information about the auxiliary equipment.

When the corresponding equipment can include auxiliary equipment as primary equipment, the information about the child EBC may include information about the auxiliary equipment.

However, information that can be included in the EBC is not limited thereto, and may include various pieces of information about the equipment. A specific structure of the EBC will be described with reference to FIG. 2.

The simulation unit 200 performs simulation using the EBC stored in the EBC storage 110 to allow the AI model to be embedded in a simulation model.

More specifically, the simulation unit 200 performs simulation using the EBC stored in the EBC storage 110. In this case, the simulation unit 200 may execute the AI model using the AI model data included in the EBC so that the AI model may be included in the simulation model.

That is, since the AI model data is already included in the EBC, when a simulation model is generated using the EBC, a simulation model in which the corresponding AI model is embedded may be generated.

FIG. 2 illustrates a structure of an EBC newly generated by the EBC storage 110.

Referring to FIG. 2, the EBC may include properties of equipment, behavior of the equipment, and an external interaction with external equipment, but the present invention is not particularly limited thereto.

A property set includes profile data, specification data, operation data, and AI model data for an AI model.

The profile data, the specification data, and the operation data may include AI model data.

The profile data may include an equipment manufacturer name, an equipment type name, and the like.

The specification data may include a size and weight of the equipment and the like.

The operation data may include a maximum cutting speed, a moving range, and the like.

Referring to FIG. 3, the AI model data may include an AI model identifier, an AI model name, an input data set, output data, framework information, a framework help library, a model file, a model source code, and the like, but the present invention is not particularly limited thereto.

Referring to FIG. 4, the behavior of the equipment includes one or more states of the equipment and zero or more state transitions.

The state of the behavior may include a state identifier, a state name, an entry execution code, and an exit execution code.

The entry execution code of the state of the behavior and the exit execution code of the state of the behavior may include the AI model.

The state transition of the behavior may include a state transition identifier, a state transition name, a state transition condition, a source state identifier, a destination state identifier, a state transition execution code, and the like.

The state transition execution code of the state transition of the behavior may include the AI model.

Referring to FIG. 5, the external interaction may include zero or more state transitions.

The external interaction may include an external interaction identifier, an external interaction name, a source equipment identifier, a destination equipment identifier, a state identifier, a state entry execution code, a state exit execution code, a state transition identifier, a state transition condition, and a state transition execution code.

The state transition execution code of the external interaction may include the AI model.

The external interaction may occur in the state or state transition of the behavior.

When the external interaction occurs in the state of the behavior, a message or the like corresponding to the external interaction may be transmitted to other equipment or a message corresponding to the external interaction may be received from other equipment through the state entry execution code or state exit execution code of the behavior.

The entry execution code or exit execution code of the state of the behavior may include the AI model.

When the external interaction occurs in the state transition of the behavior, a message or the like corresponding to the external interaction may be transmitted to other equipment or a message corresponding to the external interaction may be received from other equipment through the state transition execution code of the behavior.

The state transition execution code of the state transition of the behavior may include the AI model.

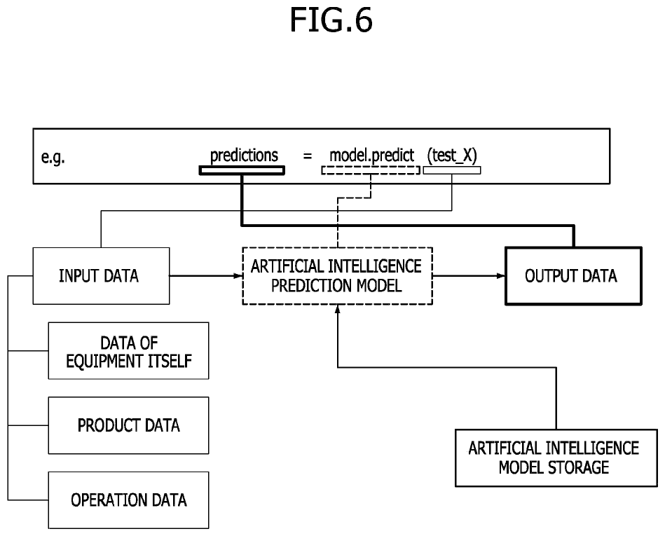

FIG. 6 is a diagram illustrating an example of an embedded AI model according to an embodiment of the present invention.

Referring to FIG. 6, the AI model may be a pre-trained AI model.

The pre-trained AI model uses a prediction function predict( ) to obtain a prediction result.

In the prediction function predict( ), a set of input data is used as an input.

The set of input data of the pre-trained AI model may be one or more of data of equipment itself, product data, and operation data.

Output data of the pre-trained AI model may be static or dynamic values of one or more variables of a simulation model.

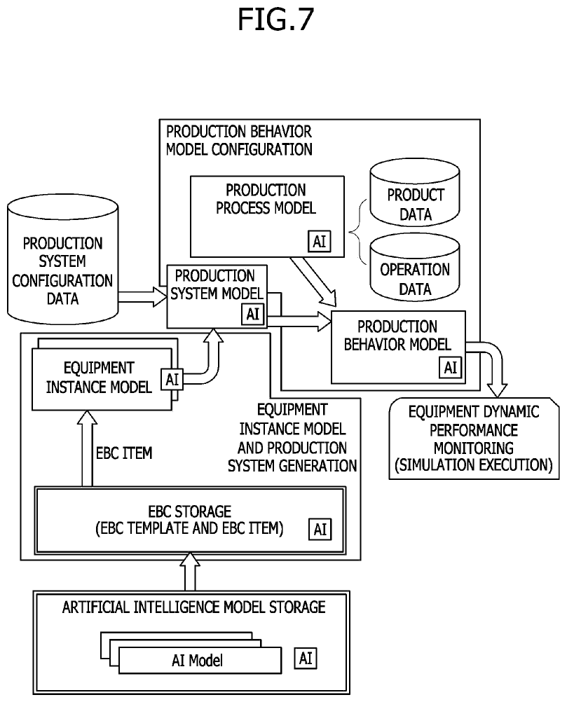

FIG. 7 is a data flow diagram of the case in which an EBC in which an AI model according to an embodiment of the present invention is embedded is used.

Referring to FIG. 7, the AI model is embedded in templates and items of the EBC stored in the EBC storage 110 according to the present embodiment.

When the AI model is included in an item of an EBC selected from an upper EBC storage 110, an equipment instance model that includes an AI model may be generated, and when the AI model is not included, an equipment instance model that does not include an AI model may be generated.

The equipment instance model may be a model that generates virtual equipment on the basis of information included in the EBC.

A production system model may be built by utilizing production system configuration data with equipment instance models that include an upper AI model or equipment instance models that do not include an AI model.

A production behavior model including an AI model may be built by utilizing an upper production system model and a production process model that uses product data and operation data.

The production process model may be generated by extracting information about a production product and information about a process, which are requested by a user and are required in a virtual factory, on the basis of product information and process information.

An output of simulation using an upper production behavior model may be used to monitor performance of equipment and a system, including monitoring performance of AI.

As described above, in an embodiment of the present invention, an AI model is embedded in an existing equipment catalog template to build an equipment instance model that uses the AI model, and an EBC in which the AI model is embedded is used for simulation of a virtual production system.

According to an aspect of the present invention, in the present invention, an AI model can be embedded in an existing equipment catalog template to build an equipment instance model that uses the AI model.

According to another aspect of the present invention, in the present invention, productivity and efficiency of a production system can be accurately predicted by linking a simulation model and an AI model, and thus prediction errors between an actual production system and a virtual production system can be reduced.

According to still another aspect of the present invention, in the present invention, by utilizing an equipment instance model that uses an AI model as an alternative to univariate/multivariate probability distribution variables, behavior approximation of components that require a high level of detail, etc., it is possible to build a production system model, a production behavior model, and the like.

While the present invention has been described with reference to embodiments illustrated in the accompanying drawings, the embodiments should be considered in a descriptive sense only, and it should be understood by those skilled in the art that various alterations and other equivalent embodiments may be made. Therefore, the scope of the present invention should be defined by only the following claims.

What is claimed is:

1. An apparatus for configuring an equipment behavior catalog (EBC), which is for an artificial intelligence model embedding, comprising:
an artificial intelligence model storage configured to store an artificial intelligence model; and
an EBC storage configured to store an EBC including artificial intelligence model data for the artificial intelligence model stored in the artificial intelligence model storage.

2. The apparatus of claim 1, wherein the EBC includes at least one of properties of equipment, behavior of the equipment, and an external interaction with external equipment.

3. The apparatus of claim 2, wherein the properties of the equipment include at least one of profile data, specification data, operation data, and data for the artificial intelligence model.

4. The apparatus of claim 3, wherein the artificial intelligence model data includes at least one of an artificial intelligence model identifier, an artificial intelligence model name, an input data set, output data, framework information, a framework help library, a model file, and a model source code.

5. The apparatus of claim 2, wherein the behavior of the equipment includes a state of the behavior,
the state of the behavior includes at least one of a state identifier, a state name, an entry execution code, and an exit execution code of the behavior, and
the entry execution code of the state of the behavior or the exit execution code of the state of the behavior includes the artificial intelligence model data.

6. The apparatus of claim 5, wherein the behavior of the equipment further includes a state transition of the behavior,
the state transition of the behavior includes at least one of a state transition identifier, a state transition name, a state transition condition, a source state identifier, a destination state identifier, and a state transition execution code, and
the state transition execution code includes the artificial intelligence model data.

7. The apparatus of claim 2, wherein the external interaction includes at least one of an external interaction identifier, an external interaction name, a source equipment identifier, a destination equipment identifier, a state identifier, a state entry execution code, a state exit execution code, a state transition identifier, a state transition condition, and a state transition execution code, and
the state entry execution code, the state exit execution code, and the state transition execution code include the artificial intelligence model data.

8. The apparatus of claim 1, wherein the artificial intelligence model uses a prediction function,
input data of the prediction function is data of the EBC, and
output data of the prediction function is static or dynamic values of one or more variables of a simulation model.

9. The apparatus of claim 1, wherein the EBC storage is configured to store the artificial intelligence model.

10. The apparatus of claim 1, wherein, in the EBC storage, data or a parameter of the EBC is replaced with the artificial intelligence model, part or all of behavior of equipment is replaced with the artificial intelligence model, or equipment serving as a component in complex equipment is replaced with the artificial intelligence model.

11. A virtual production system using an equipment behavior catalog (EBC), which is for artificial intelligence model embedding, comprising:
an apparatus for configuring an EBC configured to form and store artificial intelligence model data for an artificial intelligence model; and
a simulation unit configured to perform simulation using the EBC to allow the artificial intelligence model to be embedded.

12. The virtual production system of claim 11, wherein the apparatus for configuring the EBC includes:
an artificial intelligence model storage configured to store an artificial intelligence model; and
an EBC storage configured to form and store an EBC including artificial intelligence model data for the artificial intelligence model stored in the artificial intelligence model storage.

13. The virtual production system of claim 11, wherein the EBC includes at least one of properties of equipment, behavior of the equipment, and an external interaction with external equipment.

14. The virtual production system of claim 12, wherein the properties of the equipment include at least one of profile data, specification data, operation data, and data for the artificial intelligence model.

15. The virtual production system of claim 14, wherein the artificial intelligence model data includes at least one of an artificial intelligence model identifier, an artificial intelligence model name, an input data set, output data, framework information, a framework help library, a model file, and a model source code.

16. The virtual production system of claim 13, wherein the behavior of the equipment includes a state of the behavior,
the state of the behavior includes at least one of a state identifier, a state name, an entry execution code, and an exit execution code of the behavior, and
the entry execution code of the state of the behavior or the exit execution code of the state of the behavior includes the artificial intelligence model data.

17. The virtual production system of claim 16, wherein the behavior of the equipment further includes a state transition of the behavior,
the state transition of the behavior includes at least one of a state transition identifier, a state transition name, a state transition condition, a source state identifier, a destination state identifier, and a state transition execution code, and
the state transition execution code includes the artificial intelligence model data.

18. The virtual production system of claim 13, wherein the external interaction includes at least one of an external interaction identifier, an external interaction name, a source equipment identifier, a destination equipment identifier, a state identifier, a state entry execution code, a state exit execution code, a state transition identifier, a state transition condition, and a state transition execution code, and
the state entry execution code, the state exit execution code, and the state transition execution code include the artificial intelligence model data.

19. The virtual production system of claim 12, wherein the artificial intelligence model uses a prediction function,
input data of the prediction function is data of the EBC, and
output data of the prediction function is static or dynamic values of one or more variables of a simulation model.
